(19) United States
(12) Patent Application Publication
(10) Pub. No.: US 2016/0140553 A1
(43) Pub. Date: May 19, 2016

(54) AUTHENTICATION AND TRANSACTIONS IN A THREE-DIMENSIONAL IMAGE ENHANCING DISPLAY DEVICE

(71) Applicant: Visa International Service Association, San Francisco, CA (US)

(72) Inventors: PATRICK FAITH, Foster City, CA (US); THEODORE HARRIS, Foster City, CA (US)

(21) Appl. No.: 14/944,191

(22) Filed: Nov. 17, 2015

Related U.S. Application Data
(60) Provisional application No. 62/080,839, filed on Nov. 17, 2014.

(51) Int. Cl. G06Q 20/40; G06T 19/00; G06Q 20/32

(52) U.S. Cl. CPC G06Q 20/401; G06Q 20/3227; G06Q 20/3224; G06T 19/006

(57) ABSTRACT

A computerized method for facilitating a purchase transaction for a user in a first reality environment. The method includes receiving at least one level of authentication data of the user from a three-dimensional image enhancing device. The at least one level of authentication data is transmitted to a central computing device for comparing the at least one level of authentication data to a set of known authentication data of the user stored in a memory. In response to receiving a confirmation from the central computing device, an object is provided to the user for purchase in the first reality environment via the three-dimensional image enhancing device. An interaction of the user to interact with the object in the first reality environment is identified. The method completes the purchase transaction if it is determined that the interaction is to complete the purchase transaction of the object.

### CROSS-REFERENCE TO RELATED APPLICATIONS

This is the nonprovisional application for provisional application, Ser. No. 62/080,039, filed on Nov. 17, 2014, whose disclosure is incorporated by reference in its entirety herein. The present application is also related to an international PCT application filed on Nov. 17, 2015, application number PCT/US15/61197, whose disclosure is incorporated by reference in its entirety herein.

### FIELD OF DISCLOSURE

The present disclosure relates to three dimensional environments, and more specifically, to authentication and transactions in a three dimensional image enhanced environment.

### BACKGROUND

As the world moves into using technology to augmented and virtual realities, new problems and opportunities are created. In terms of opportunities, users may be able to use technology to view images in more detail and with more information than was previously possible. In terms of problems, new versions of fraud and deceitful behavior are possible. Thus, it would be helpful to have a system that would leverage the three dimensional devices to provide additional security while present new opportunities for users and sponsors.

### SUMMARY

A method of determining whether a transaction is authorized in a three dimensional augmented reality is disclosed. The system may program a processor for receiving first image data from a first image sensor wherein the first image sensor is attached to a three-dimensional image enhancing device or a three dimensional visualization device and for receiving second image data from a second image sensor wherein the second image sensor is attached to the three-dimensional image enhancing device or the three dimensional visualization device. The first image data and the second image data may be communicated to the central computing device. The first image may be compared to a known first image and a similarity score may be determined. The second image may be compared to a known second image and a second similarity score may be determined. Transaction data related to a user of the three-dimensional image enhancing device or the three dimensional visualization device may be received. The similarity score and the second similarity score may be summed and if the sum of the similarity score and the second similarity score are over a threshold, authorizing the transaction.

According to one embodiment, a computerized method facilitates a purchase transaction for a user in a first reality environment. The first reality environment is provided to the user via a three-dimensional image enhancing device. The computerized method includes receiving a first authentication data of the user from the three-dimensional image enhancing device. The received first authentication data of the user is compared to a set of known authentication data of the user stored in a memory accessible by the three-dimensional image enhancing device. In response to the comparing, the method further includes receiving a second authentication data of the user from the three-dimensional image enhancing device. The received second authentication data of the user is compared to the set of known authentication data of the user stored in the memory accessible by the three-dimensional image enhancing device. In response to the comparing, an object is provided to the user for purchase in the first reality environment via the three-dimensional image enhancing device. The method further includes identifying an interaction of the user in a second reality environment to interact with the provided object in the first reality environment. It is determined whether the identified interaction is to complete the purchase transaction of the object. The purchase transaction of the object is completed in response to the determination being affirmative.

According to yet another embodiment, a computerized method facilitates a purchase transaction for a user in a first reality environment, and the first reality environment may be provided to the user via a three-dimensional image enhancing device. The method includes receiving at least one level of authentication data of the user from the three-dimensional image enhancing device. The at least one level of authentication data includes at least one of the following: image data obtained via the three-dimensional image enhancing device, audio data from a second reality environment, visual data from the second reality environment, location-based data from the second reality environment and a combination of sound data and image data, said second reality environment being different from the first reality environment. The method further includes transmitting the received at least one level of authentication data to a central computing device for comparing the received at least one level of authentication data of the user to a set of known authentication data of the user stored in a memory accessible by the central computing device and the three-dimensional image enhancing device. In response to receiving a confirmation from the central computing device, an object is provided to the user for purchase in the first reality environment via the three-dimensional image enhancing device. The method also includes identifying an interaction of the user to interact with the provided object in the first reality environment. The method completes the purchase transaction if it is determined that the interaction is to complete the purchase transaction of the object.

According to a further embodiment, a system facilitates a purchase transaction for a user in a first reality environment. The system includes a three-dimensional image enhancing device for providing the first reality environment to the user. The user is sensory responsive to the first reality environment and a second reality environment. The three-dimensional image enhancing device includes a processor and a memory. A central computing device is accessible to a central memory via a network, and processor is accessible to the central computing device via the network. The system further provides that the processor receives at least one level of authentication data of the user from the three-dimensional image enhancing device. The at least one level of authentication data includes at least one of the following: image data obtained via the three-dimensional image enhancing device, audio data from a second reality environment, visual data from the second reality environment, location-based data from the second reality environment and a combination of sound data and image data. The second reality environment is different from the first reality environment. The processor transmits the received at least one level of authentication data to the central computing device for comparing the received at least one level of authentication data of the user to a set of known authentication data of the user stored in the central memory to validate the user. In response to the comparing, the central computing device transmits a confirmation to the processor. The processor provides an object to the user for purchase in the first reality environment via the three-dimensional image enhancing device. The processor identifies an interaction of the user in the second reality environment to interact with the provided object in the first reality environment. The processor further determines the identified interaction to complete the purchase transaction of the object. The processor completes the purchase transaction of the object in response to the determination being affirmative.

### BRIEF DESCRIPTION OF THE DRAWINGS

FIG. 1 may be an illustration of a three dimensional image enhancing device according to one embodiment of the invention;

FIG. 2 may illustrate a three dimensional image displayed to a non-authenticated user via the three dimensional image enhancing device according to one embodiment of the invention;

FIG. 3 may illustrate a three dimensional image displayed to an authenticated user via the three dimensional image enhancing device according to one embodiment of the invention;

FIG. 4A may illustrate a user reaching for an object in three dimensional space while using the three dimensional image enhancing device from the point of view of an outside observer according to one embodiment of the invention;

FIG. 4B may illustrate a three dimensional image displayed to an authenticated user while the user attempts to select goods and services in the three dimensional space according to one embodiment of the invention;

FIG. 5 illustrates an example routine or process flow diagram for authenticating financial transaction based on both authenticating a user and a particular location at which the transaction is attempting to be conducted according to one embodiment of the invention;

FIG. 6 may illustrate a three dimensional image displayed to a user while the user attempts to view and purchase goods or services in a three dimensional space according to one embodiment of the invention;

FIG. 7 may illustrate a three dimensional image displayed to a user after the user has entered a designated area within a three dimensional space according to one embodiment of the invention;

FIG. 8 may illustrate a three dimensional image displayed to a user while the user attempts to view and purchase goods or services that may or may not be verified in a three dimensional space according to one embodiment of the invention;

FIG. 9 may illustrate a three dimensional image displayed to a user while the user attempts to pay for or return a good or service in a three dimensional space according to one embodiment of the invention; and

FIG. 10 may illustrate a three dimensional image displayed to a user while the user attempts to create and three dimensional print an object in a three dimensional space according to one embodiment of the invention.

FIG. 11 may illustrate an exemplary system for facilitating a user to complete a purchase transaction according to one embodiment of the invention.

Corresponding reference characters indicate corresponding parts throughout the drawings.

### DETAILED DESCRIPTION

At a high level, a three dimensional image enhancing device may be used to add additional depth and lifelikeness to a user's vision. The three dimensional enhancing image device may display, to a user, a three dimensional image that may have additional depth and focus and may allow a user to see images in a new and exciting way. In addition, a user may be able to be authenticated in an improved manner using the three dimensional image enhancing device. The three dimensional image enhancing device may also have speakers which enhance the viewing experience. Once a user is authenticated, the user may be presented a variety of additional display options that have been determined to be safe for the authenticated user.

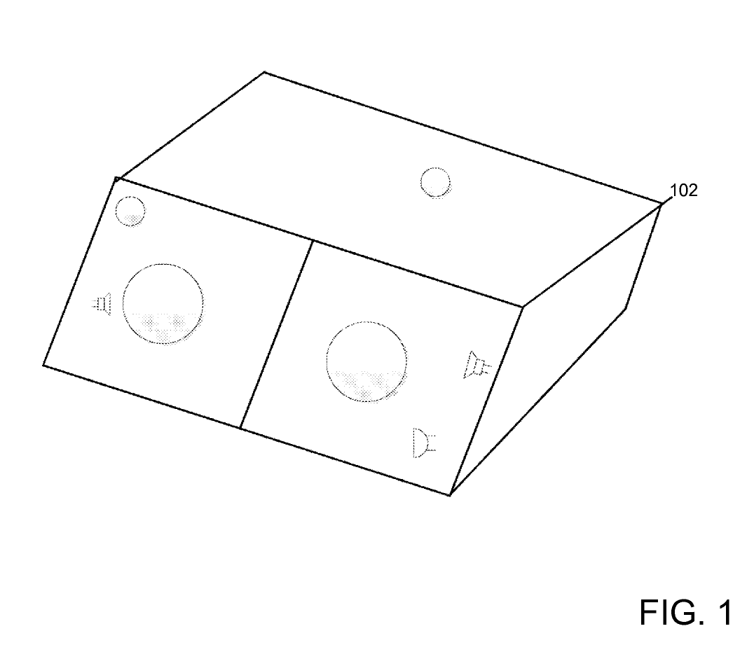

The three dimensional image enhancing device may have a variety of forms and a variety of electronic computing equipment that implement one or more types of three dimensional image rendering. For example, as shown in FIG. 1, the three dimensional image enhancing device 102 may use stereoscopic principles and may have a display that displays a first image to a first eye and a second image to a second eye. The first image and second image may be related but slightly offset to create a three dimensional image as is known. The first eye and second eye may be separated by a physical device. In some embodiments, the three dimensional device may allow in a minimal amount of additional light. In another embodiment, the three dimensional device may be partially opaque and may allow the user to see the outside world with additional reality details displayed on a lens of the device via a transparent liquid crystal display (LCD) for example.

A first image sensor may be pointed at the eye of a user. The image sensor may be a camera and may also capture lights outside of the visible spectrum. As a result, the first image sensor may be able to capture images of a retina of a user. The image of a retina may be unique about users when viewed with sufficient detail and may be used to identify a user.

The image sensor may also have the ability to track the movement and focus of one or both eyes of a user. Thus, the image sensor may operate as an ocular sensor, which may be used for a variety of purposes as will be explained. Further, in some embodiments, there may be a plurality of image sensors pointed at the eyes of the user such that even more precision in tracking eye movements may be possible.

An additional image sensor may be used to capture images outside the three dimensional image enhancing device. For example, the image sensor may look in the forward direction from the three dimensional image enhancing device. In another example, there may be a plurality of additional image sensors and the image sensors may be pointed in a variety of directions and may be combined to create a 360 degree view around the user.

A processor may also be included in the vision device, such as the three-dimensional image enhancing device. The processor may have a variety of functions. In one aspect, the processor may receive images from the first image sensors and the second image sensors. In another aspect, the processor may control communications to and from the three dimensional image enhancing device. The images may be formatted and communicated to a central computing device and additional images may be communicated to the vision device to be illustrated on the display.

In some embodiments, the processor may also receive communications from the central computing device. For example, central computing device may indicate whether the user has been authenticated and the authentication may be determined in a variety of ways.

In one embodiment, authentication may take the first image and determine if the image is sufficiently similar to a stored image for a user. The first image may be of a retina and the first image may be compared to a stored retina for the user. The comparison may be given a score and the score may be tested to determine if it is over a threshold. If the score is over a threshold, an indication may be made that the user is known and the transaction is not fraudulent. If the score is not over a threshold, an indication may be made that the user is not known and that the transaction is likely fraudulent.

In addition, more data may be analyzed to determine authentication. The second image may also be analyzed to determine if it is recognized. For example, if a user's account has a pending transaction for a grocery store and the second image is from that grocery store, the transaction is scored as being acceptable (e.g., the score is over a threshold). Similarly, if the pending transaction is from a grocery store and the second image is from a car dealership, the transaction is scored as not being acceptable.

As mentioned previously, additional data may be reviewed to determine if a user is known or whether a transaction is likely fraudulent. Sound data may be received through a microphone in the vision device. The sound data may be communicated to the central computing device where the sound data may be compared to previously stored sound data. In one example, the sound data may be a user's voice and the sound data may be compared to previous voice data for the user. If the voice is sufficiently similar to the stored voice, the user may be determined to be safe and if the voice data does not match stored voice data, the user may be determined to not be authorized.

Similarly, background noise may be received and reviewed. If a transaction is indicated as being at an NFL game, the background noise may be received by the central computing device and compared to previous noise at NFL games. Further, the sounds may be compared to a sound feed from the game, such as from the public address system. If the sound is determined to be sufficiently similar to the expected sounds at an NFL game, the user may be determined to be authorized. If the sounds are determined not to be sufficiently similar, the user may be determined to not be authorized.

The vision device may also have a location device such as a Global Positioning System (GPS) device. The location device may indicate a location in a manner than may be used determine the location of the user. Thus, the location indication from the GPS device may be compared to the indicated location of a transaction. If the locations are sufficiently similar, the user may be indicated as being authorized. If the location are not sufficiently similar, the user may be indicated as not being authorized.

In an additional embodiment, the location may be used to determine sounds or second images that are expected. For example, if the location signal indicates the user is at a zoo, the sights from the second image device and sounds from the microphone should be related to sounds and sights at a zoo. If the sounds are expected from the GPS signal then the user may be indicated as being authorized. If the sights and sound are not as expected, the user may be indicated as not being authorized.

The second image may also be controlled by a user. For example, the user may point the second image device at his/her hand where the fingerprints of the user may be examined. If the fingerprints match the fingerprints on file for the user, the transaction may be noted as being authorized.

Additional outside factors may be taken into account to assist in determining whether a transaction is authorized. For example, if a user is riding on a train, the train may move in a predictable manner. The car rocks in a predictable manner, the noise is predictable and the location may be predictable if the train is on time. All these data points may be taken into account to determine if a user is authorized or not.

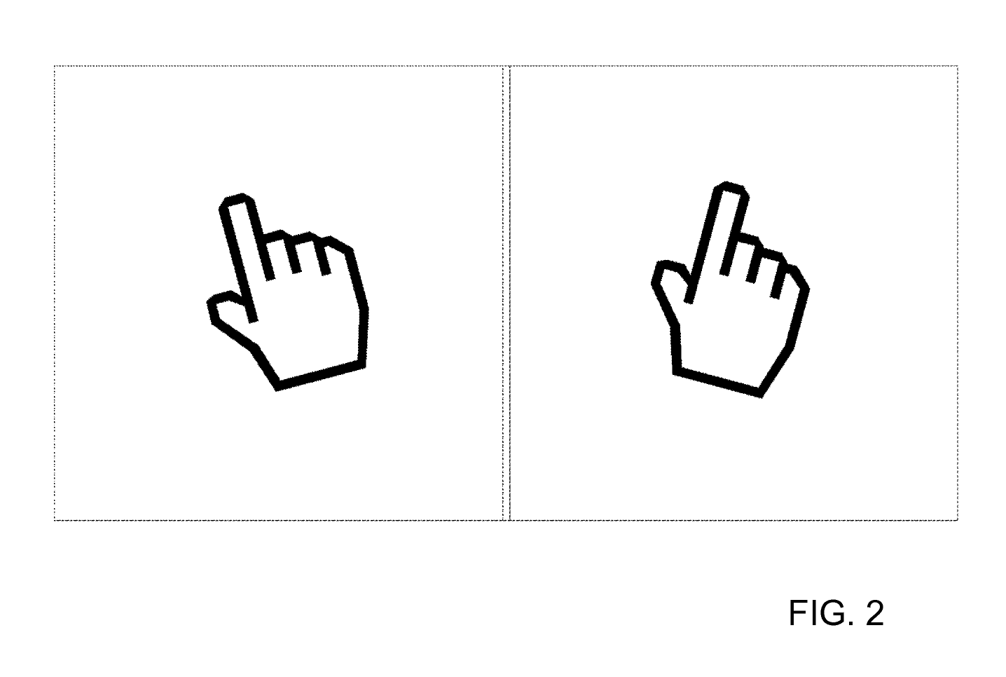

As described above, the three dimensional image enhancing device may display to a user an augmented or a virtual world that includes one or more three dimensional objects. These three dimensional image objects may be displayed in an entirely virtual reality image or as objects overlapping a real world image to create an augmented reality image. Regardless of the type of reality being displayed, the three dimensional image enhancing device may display different three dimensional objects based on the authentication status of a user. The three dimensional image enhancing device may display, as three dimensional objects, generic goods or services that are not tailored to the user or may not display any objects at all, as shown in FIG. 2, for example.

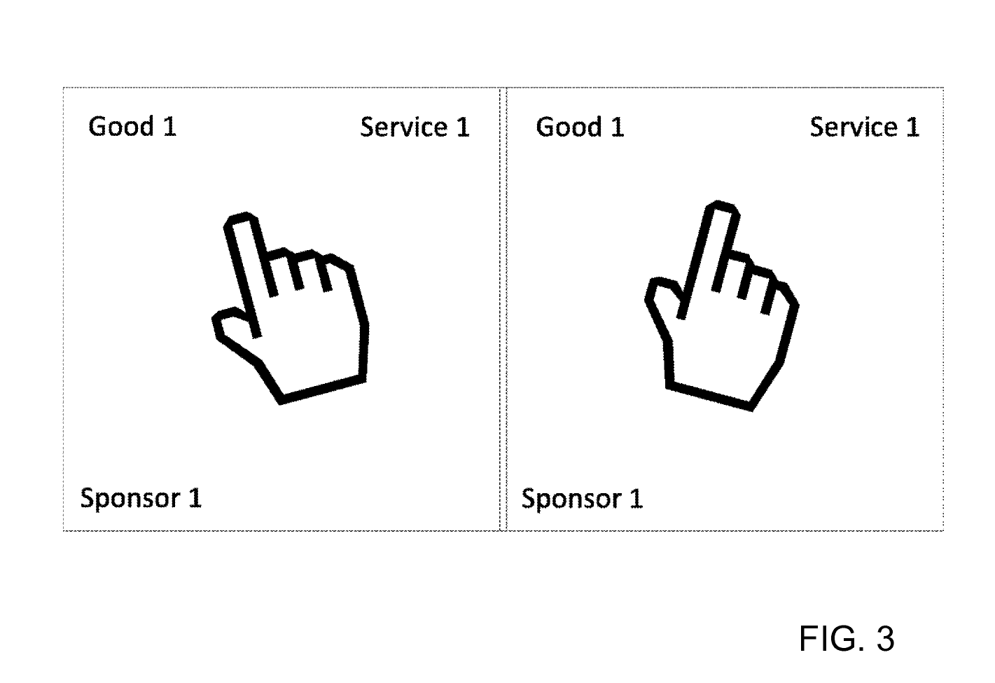

On the other hand, after the user has been authenticated by one of the manners described above or any other suitable manner of authenticating a user, the authentication of the user may trigger the three dimensional image enhancing device to display particular three dimensional objects that are specific to or tailored for the user, as illustrated in FIG. 3. For example, the three dimensional image enhancing device (or a central database, etc.) may store preference data associated with the authenticated user. This preference data may indicate that the user prefers a particular type of soft drink, and in response to retrieving this preference data in this example, the three dimensional image enhancing device may display a three dimensional object that depicts a realistic image of a bottle (or otherwise symbolically represents) a specific type of soft drink based on the preference data of the user.

Moreover, after the user has been properly authenticated, the three dimensional image enhancing device may display a logo, a brand mark, a brand symbol, a label, etc., on the one or more of the displayed three dimensional objects. In this implementation, the logo may indicate to the user that the user may purchase the product represented by the three dimensional object because i) the user has been authenticated to perform transactions and ii) the merchant of the labeled product is willing (e.g., available quantities in stock) and able (e.g., age restriction requirements, etc.) to sell the product to the particular authenticated user. For example, the three dimensional image enhancing device may receive not only preference data of the user but may also retrieve product data and merchant data and may associate a logo or any other label that indicates the displayed bottle of the soft drink may be purchased by the authenticated user. However, the three dimensional image enhancing device may display, to a different authenticated user, only the three dimensional product object without a logo (indicating that the particular three dimensional object is not able to be purchased by the different user), or the three dimensional image enhancing device may not display the product object at all based on the preference data of the different user.

Moreover, the three dimensional object may include images, depictions, illustrations, etc. of real world tangible items, people, etc. For example, the three dimensional image enhancing device may display a three dimensional video of a music concert to a user while the user is wearing the three dimensional image enhancing device. Continuing this example, if the user has not been authenticated, the three dimensional image enhancing device may only display the three dimensional video of the singer of the music concert. However, in response to authenticating the user, the three dimensional image enhancing device may not only display the three dimensional video of the singer but may also display a logo (i.e., the logo indicating that the item is able to be purchased) on each item of clothing the singer is wearing, a three dimensional object affixed with the logo that represents the song or album associated with the current song the singer is singing, a three dimensional object affixed with the logo that represents tickets for an upcoming live concert, etc.

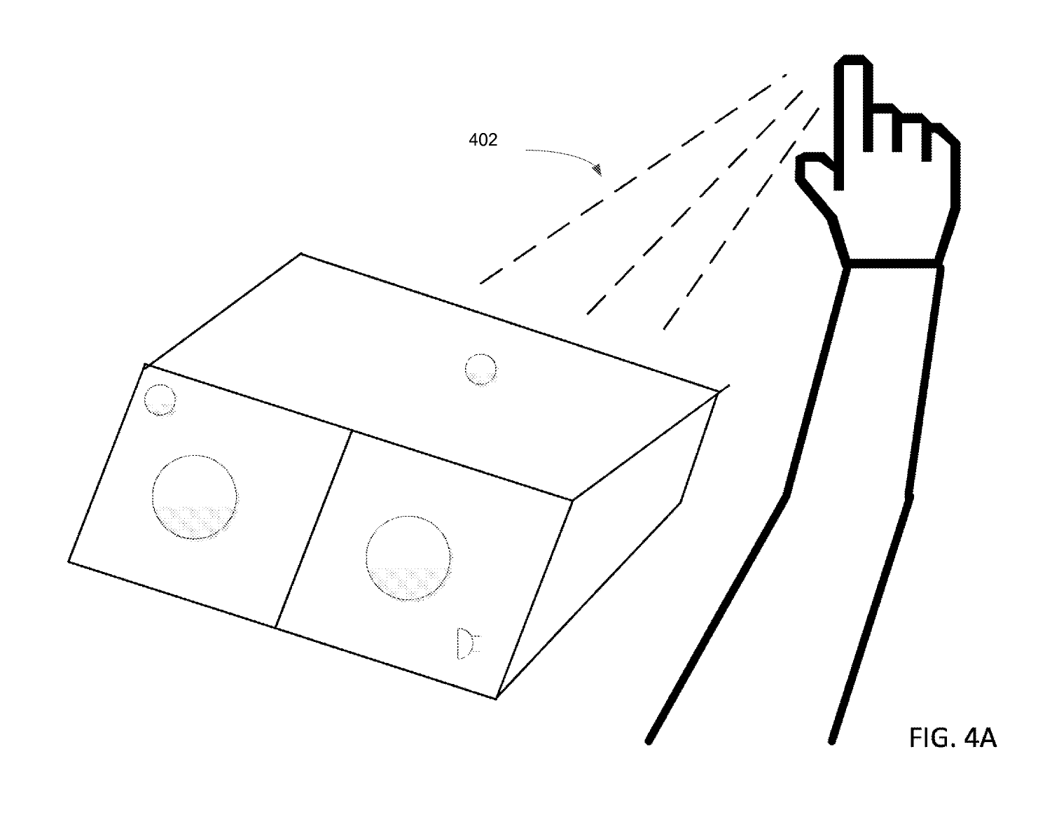

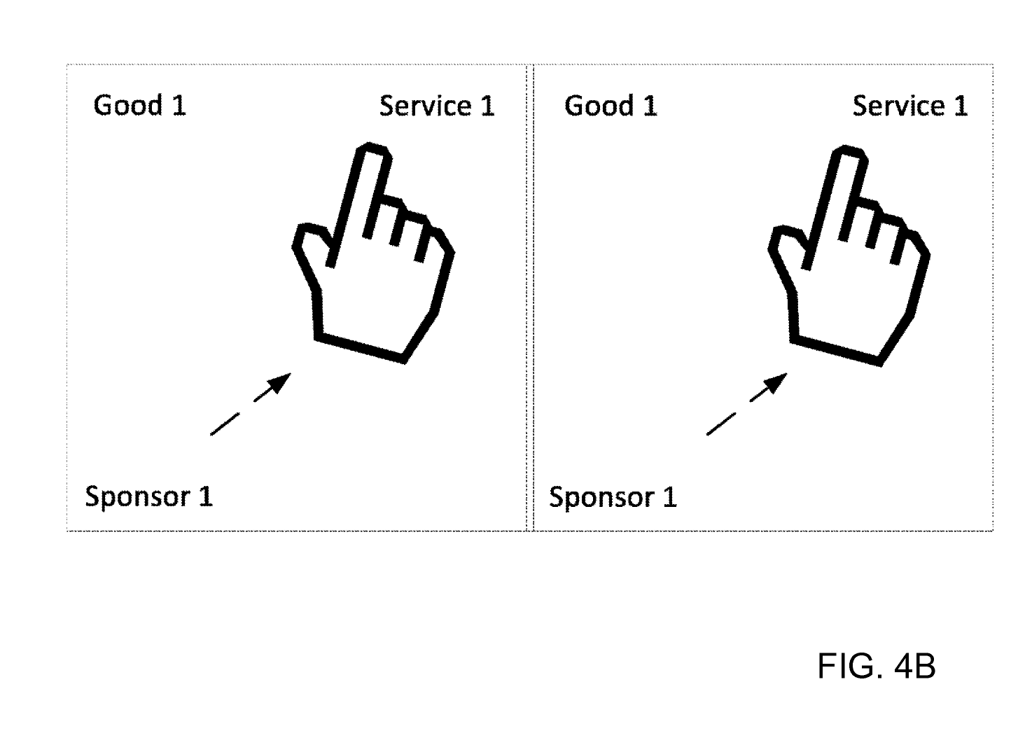

In order to buy a purchasable item (i.e., a three dimensional object associated with the logo), the user may perform any number of actions to execute the transaction. For example, as illustrated in FIG. 4A and from the point of view of an outside observer, the user may reach his or her hand out forward 402, while wearing the three dimensional image enhancing device, toward what appears to the user to be the three dimensional object rendered from the three dimensional image enhancing device. From the point of view of the user wearing the three dimensional image enhancing device as shown in FIG. 4B, however, the user may appears as though he or she is attempting to interact with or grab the three dimensional object in the virtual reality or augmented reality environment from the three dimensional image that is projected or displayed by the three dimensional image enhancing device. In response to the authenticated user “grabbing” or interacting with the three dimensional object, the three dimensional image enhancing device may transmit transactional data (e.g., item code, UPC, dollar amount, user identification, or any other data necessary to execute a transaction) to a payment processor via a payment processing network, for example.

In this example, the three dimensional image enhancing device may track the arm, hand, fingers, etc. of the user via any suitable manner. For instance, the three dimensional image enhancing device may include a Bluetooth low energy (BLE) receiver that may receive BLE signals from one or more wearable devices (i.e., a smart watch, smart glove, smart ring(s), electromagnetic field distortion detector, etc.) attached to the user's arm, wrist, hand, fingers etc., or from a portable device that the user is holding. The BLE signals may include spatial data that may be used to determine the position of the user's arm, wrist, hand, and/or fingers. The three dimensional image enhancing device may use this spatial data to determine if the user is attempting to execute a transaction by “grabbing” a particular three dimensional object projected in the display. In response to determining that the user has performed a grab motion, the three dimensional image enhancing device may execute the transaction between the user and the merchant selling the product associated with the user-selected three dimensional object.

In the alternative, the three dimensional image enhancing device may allow the user to utilize a gaming controller, mobile device, etc. to control a three dimensional cursor that is capable of executing a transaction. For example, the user may utilize the three dimensional cursor device to “click” or otherwise select a particular three dimensional object and subsequently perform the transaction in response to the user's selection.

As an additional level of security and to prevent accidental “grab” purchases, the three dimensional image enhancing device may detect a “signature” from the user, via a wearable device, to execute a transaction in which the user signs his or her name in mid-air in front of himself or herself. In this example, the three dimensional image enhancing device may again, track the movement of the user's wrist, hand, fingers, etc. over a time period to determine whether the tracked movement of the user's signature is sufficiently similar to a stored signature of the user. After the three dimensional image enhancing device determines the that the signature is sufficiently similar, via a similarity threshold for instance, the three dimensional image enhancing device may execute the transaction.

In addition to purchasing physical goods and products by selecting a three dimensional representation of the product, the three dimensional image enhancing device may also display three dimensional objects that represent non-tangible goods, such as theater/movie tickets, charity donations, digital magazine/newspaper subscriptions, or even instantaneous video streaming services. Advantageously, the three dimensional image enhancing device may assist in preventing video stream viewing by unauthorized users. For example, one user may properly subscribe to a video streaming service that allows the user to log in with his or her credentials and to instantaneously view a video whenever desired. However, in this example, the user may inappropriately share his or her log in credentials with other users that also begin viewing videos at a loss of revenue to the video streaming service.

To combat this unauthorized video streaming by the other users in this continued example, the three dimensional image enhancing device may use user authentication to prevent the unauthorized video streaming. As described above, the three dimensional image enhancing device may display a three dimensional object associated with the video streaming service based solely on whether an authenticated user is authorized to use the video streaming service. Additionally, by not allowing unauthorized users from using its video streaming service, the video streaming entity may not only collect more revenue, but also may better tailor content to the authorized user including enabling parental control filters on content available to a minor user.

In addition to authenticating users, the three dimensional image enhancing device may also authenticate vendors, merchants, or even goods on behalf of the user. In one implementation, the three dimensional image enhancing device may retrieve authentication data from a central authentication authority that may indicate the authentication level of a particular merchant or vendor. The central authentication authority may have created and stored authentication data based on previously vetting a particular merchant based on an application process, historical transactional data (i.e., a track record of transaction fraud issues with a particular merchant, etc.), or any other suitable manner of authenticating a merchant. In turn, after a user is authenticated, the three dimensional image enhancing device may only display three dimensional objects that represents goods, products, and services offered by authenticated merchants based on the retrieved merchant authentication data. In this manner, in addition to authenticating a user for the benefit of merchants, the three dimensional image enhancing device may additionally authenticate merchants for the benefit of users.

Furthermore, the three dimensional image enhancing device may retrieve authentication data from the central authority that indicates the authenticity of a particular product, especially for unique, rare, or non-tangible items that may be more easily counterfeited or palmed. For example, a merchant may offer an item of clothing purportedly owned by a famous celebrity. The central authentication authority may have created and stored authentication data based on previously authenticating the particular item of clothing based on an affidavit from previous owners or a specialist, a note from the celebrity, historical transactional data for the particular item (i.e., a chain of title, etc.) or any other suitable manner of authenticating the item of clothing. As a result, the three dimensional image enhancing device, in this continued example, may use this authentication data retrieved from the central authentication authority to determine whether to display a three dimensional object that represents the item of clothing to a user.

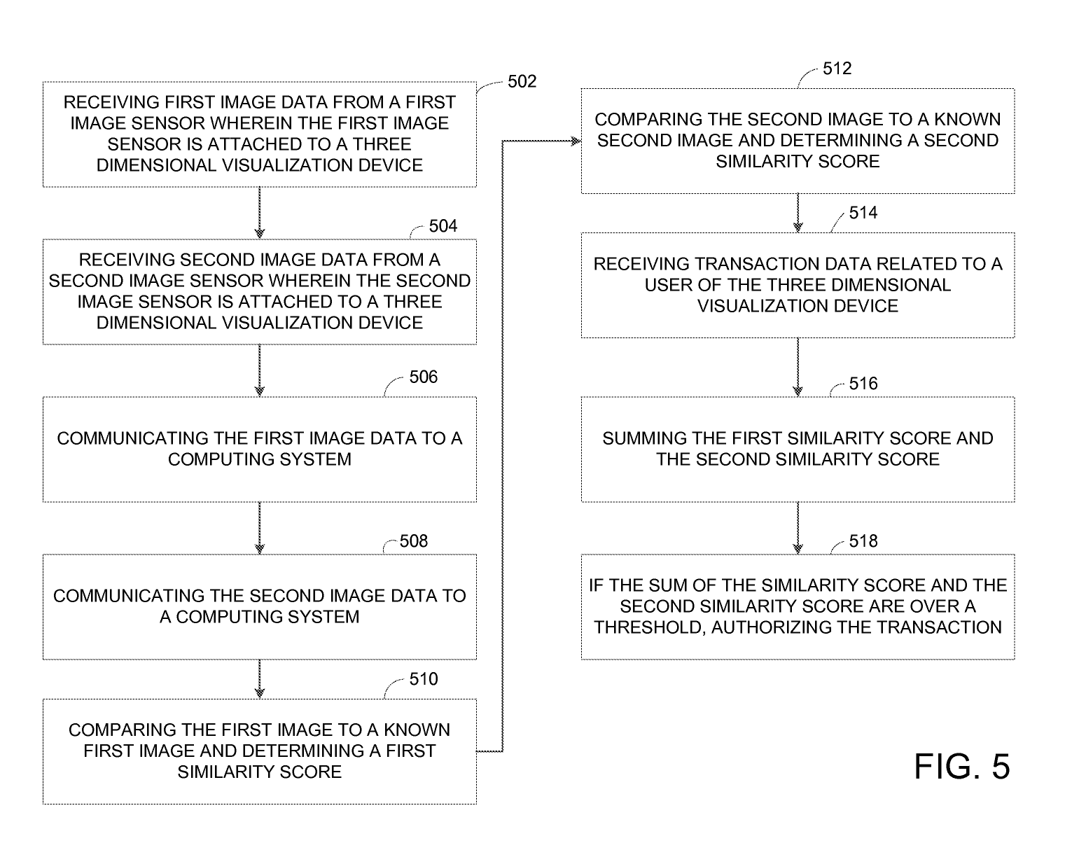

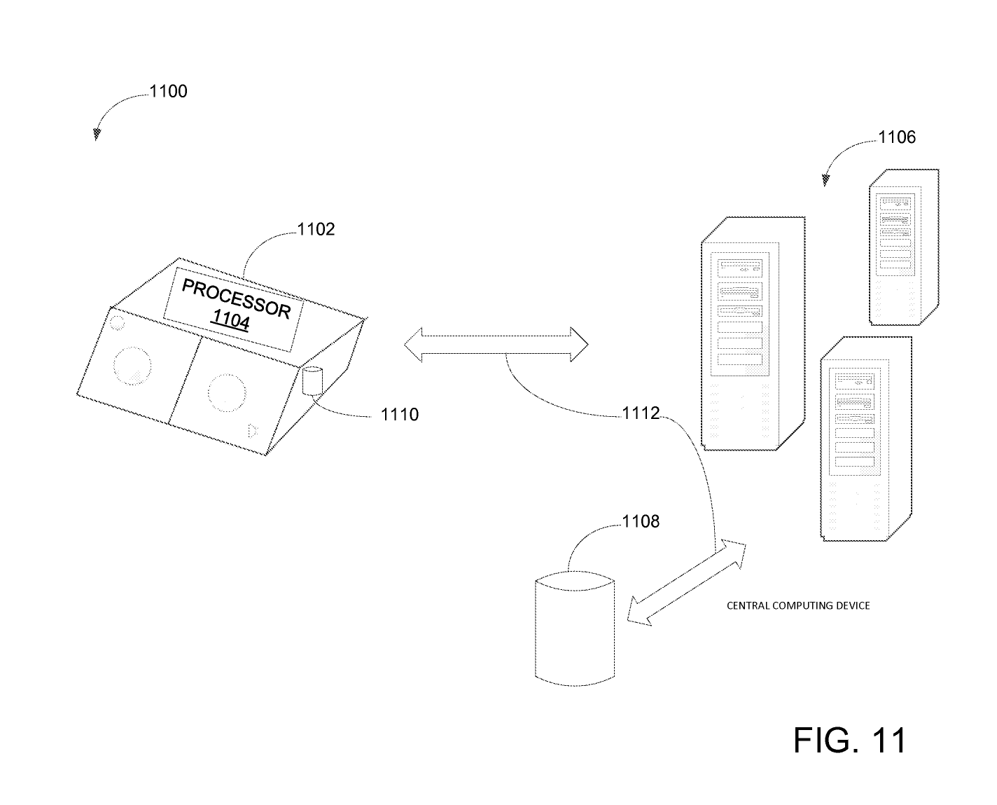

FIG. 5 illustrates a routine or process flow diagram that may be implemented by the three dimensional image enhancing device to determine whether a transaction is authorized in a three dimensional augment reality environment. For the sake of clarity, FIG. 11, illustrating an exemplary system 1100 according to one embodiment of the invention, is discussed along with FIG. 5. The three dimensional image enhancing device 1102 (with a processor 1104 and a memory 1110) executes a routine by receiving first image data from a first image sensor and second image data from a second image sensor wherein the first image sensor and the second image sensor are attached to the three dimensional image enhancing device at 502 and 504. For example, a first image sensor (positioned within the three dimensional image enhancing device) may capture first image data that includes an image of the user's retina, and a second image sensor (positioned outside the three dimensional image enhancing device) may capture second image data that includes an image of the environment surrounding the user wearing the three dimensional image enhancing device.

The routine may include communicating both the first image data and the second image data to a central computing device 1106 at 506 and 508, and in turn, the central computing device may compare the first image to a known image previously captured and generate a similarity score at 510. Likewise, the central computing device may also compare the second image to another known image previously captured and generate a similarity score at 512. For example, this may include comparing the first retina image with a database 1108 of known retina images to determine whether the user wearing the three dimensional image enhancing device is of the same identity as the user associated with the previously captured retina image. The comparing may include any matching or correlation technique to determine a similarity score of the two retina images.

The routine further includes receiving transaction data from the three dimensional image enhancing device at 514 that may include any number of pieces of information that are associated with the transaction or even associated with the three dimensional image enhancing device, such as location, dollar amount, etc. Thus, in continuing this example, the second image of the surrounding environment of the user may be compared to any previously captured images of the received location where the transaction purports to be conducted as described above and a similarity score may be determined based on the closeness of match. The routine may include summing the two similarity scores or any other suitable manner in determining an overall level of similarity at 516. If the sum of the similarity score is over a certain threshold, an authorization of the transaction may be granted and transmitted to the three dimensional image enhancing device at 518.

Referring back to FIGS. 4A and 4B, while the user is wearing the three dimensional image enhancing device, the user may view purchasable goods or services in a virtual or an augmented (e.g., partially virtual) reality three dimensional space and purchase a good or service by reaching for the good or service, for example. As, FIGS. 4A and 4B illustrate, from the user's point of view, the user may view and purchase goods or services in a three dimensional space without context or reference to any surroundings.

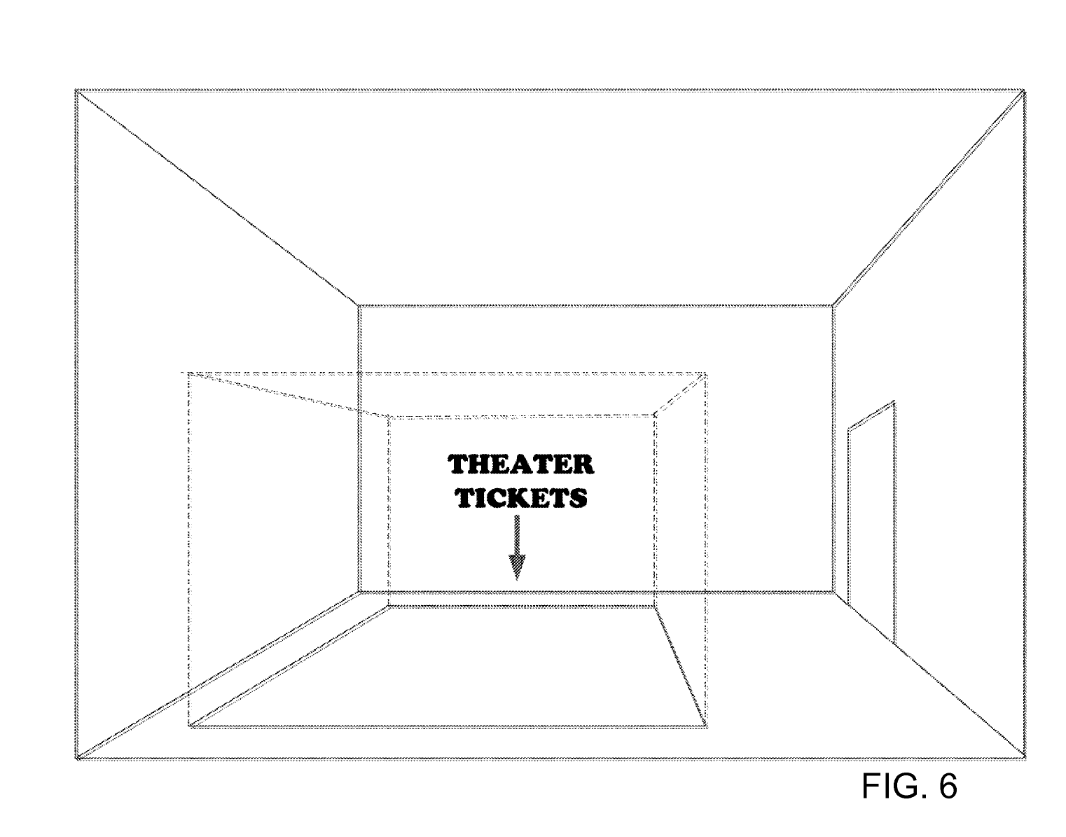

On the other hand, as illustrated in FIG. 6, a three dimensional virtual or augmented reality space for viewing and purchasing goods and services may resemble a real retail store. In this virtual three dimensional retail store, the three dimensional image enhancing device may display to the user one or more aspects to the user to allow the user to experience a more realistic shopping experience. However, because the three dimensional image enhancing device may render any type of images, any store layout, items or services sold, customer experience, etc. may be implemented. For example, the three dimensional image enhancing device may be implemented to display various items within the realistic three dimensional retail store environment. These items may be individually displayed in a realistic depiction or symbolic depiction of the good or service. For example, a movie or theater ticket may be depicted as a realistic paper ticket, as a three dimensional representation of a character of a particular theater show, etc. On the other hand, the three dimensional image enhancing device may be implemented to display to the user a high level category of a good or service and associate that category with a designated area or volume within the retail store.

As shown in FIG. 6, the three dimensional image enhancing device displays to the user, within the three dimensional space, a visually designated area that may be denoted by lines on the floor or a differently colored area on the floor (not shown) when viewed from outside the designated area. Furthermore, from afar, the user may be shown a height associated with the designated area that may denote a visually distinguishable designated volume. Similarly, this designated volume may be associated with a product or service category as well.

As described above, the three dimensional image enhancing device may allow the user to maneuver around the virtual retail store via tracking the movement of the user's arm, body, head, etc., via receiving commands from a user-controlled secondary device, or via any other suitable means to control the movement of the user within the three dimensional virtual or augmented reality environment. In this light, the user may “move” or “walk” around the three dimensional virtual retail store to better view different portions of the virtual retail store or to enter a designated area or designated volume.

Moreover, the designated area need not be visually distinguishable, but may alternatively or additionally auditorily make the user aware that he or she has entered the designated area via producing a sound for the user to hear. When the user crosses the boundary of the designated area, the three dimensional image enhancing device may reveal to the user individual products, goods, or services that were not previously displayed to the user. The particular displayed products may be specifically tailored to the user based on the user's identity (i.e., the identity of the user may be determined by one of the techniques described above) but may also be based on geographical location, age, income level, etc. of the user.

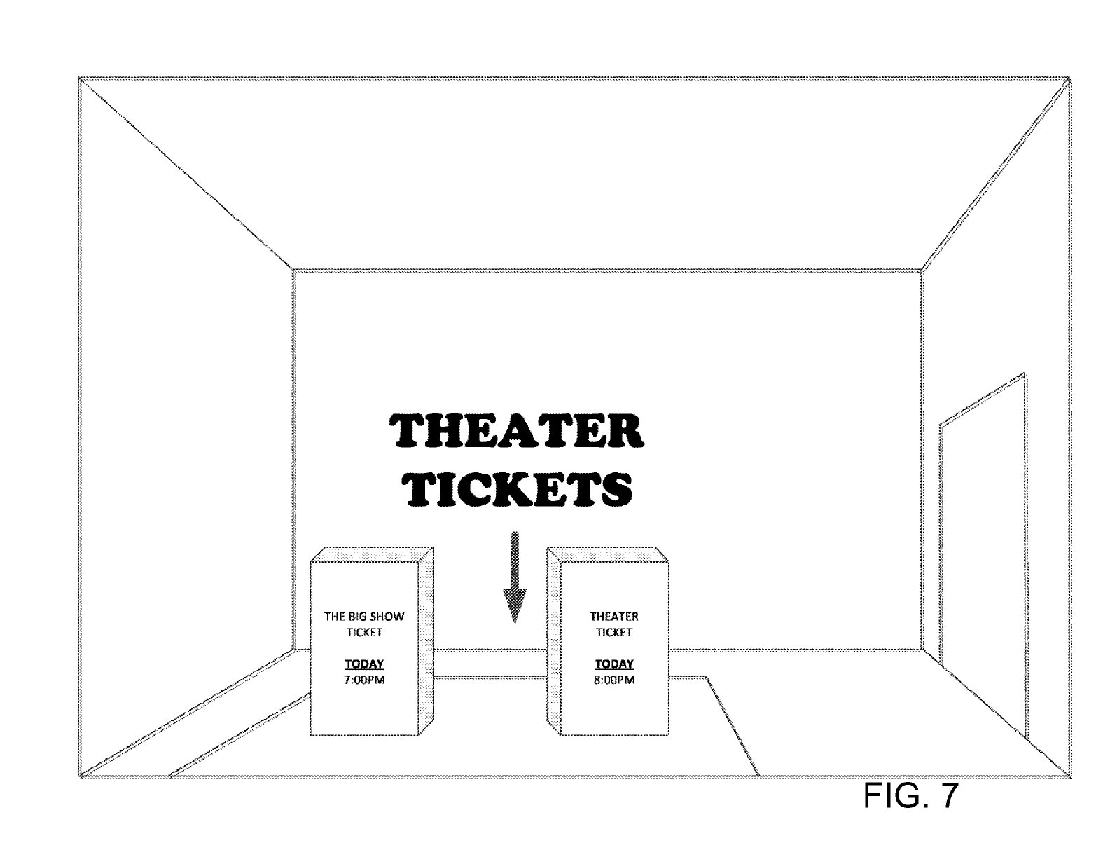

For example, as shown in FIG. 7, the user has moved or walked forward from his or her position as shown in FIG. 6 so that the user has located himself or herself within the boundaries of the designated area. As shown in FIG. 7, for example, a couple particular items are displayed by the three dimensional image enhancing device that are associated with the category, “Theater Tickets,” that was previously displayed to the user before the user “entered” the designated area (as shown in FIG. 6). In continuing this example, the three dimensional image enhancing device may determine to display these two particular items, specifically two tickets to two particular theater shows, based on any number of criteria associated with or specific to the user as listed above. The two tickets, in the alternative, may also be displayed to all users for example.

Advantageously, the three dimensional image enhancing device may display only items after the user enters the designated area to help organize a potential large number items available for sale at the virtual retail store by only showing items associated with a category after a user “selects” a category via entering the designated area associated with that category. Moreover, the three dimensional image enhancing device may beneficially display more time critical items or services to the user at the time the user enters a designated area. For example, as shown in FIG. 7, the designated area may be associated with same day tickets for theater shows, and the three dimensional image enhancing device displays, after the user enters the designated area, only tickets for shows that are still available for the current day. As another example, the three dimensional image enhancing device may show only items that are being promoted, on sale, etc.

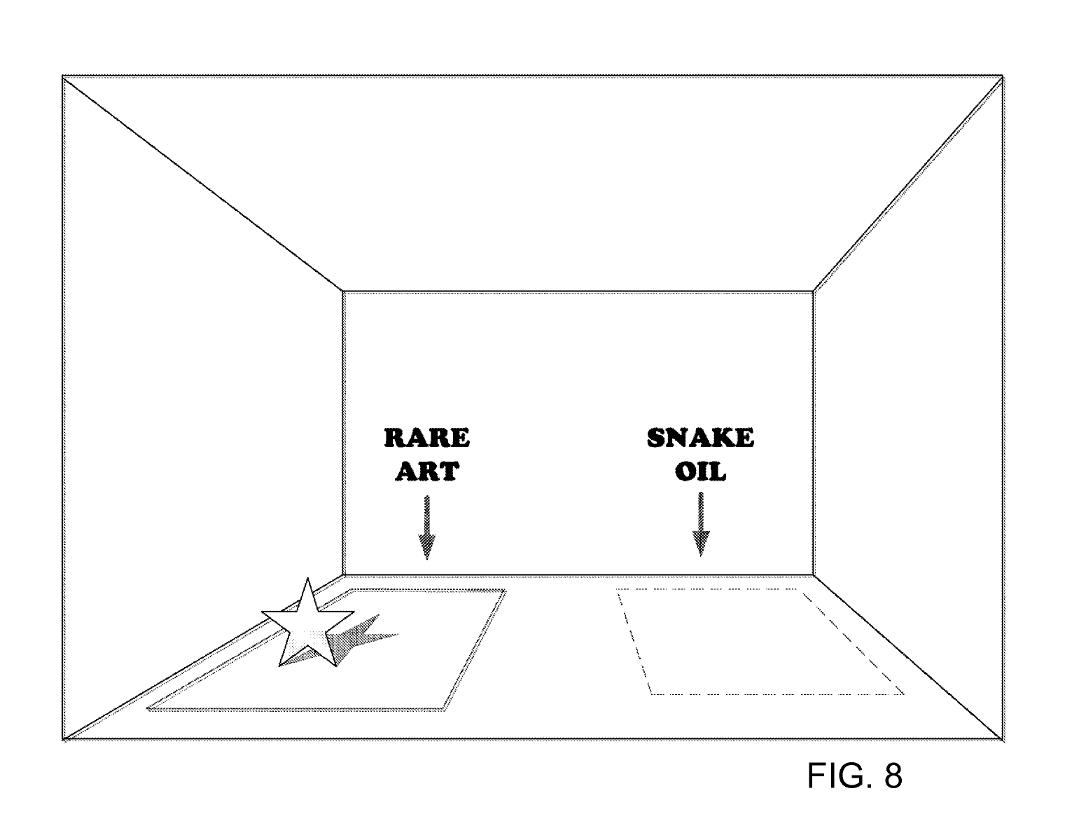

Referring now to FIG. 8, the three dimensional image enhancing device may further provide the user with a visual or auditory indicator that a particular item, merchant, category of item, etc. has been authenticated by the central computing device as described above. For example, as shown in FIG. 8, the central computing device may authenticate, in real-time or at a previous time, a piece of rare art to ensure a potential customer that the piece of rare art is authentic (e.g., the piece of rare art i) is an original piece and not replicated, ii) is truly created by the artist as purported, iii) includes a legitimate chain of title, etc.). Continuing this example, the three dimensional image enhancing device receives a notification that the piece of rare art is authentic from the central computing device, and in response, displays an authentication indicator, such as a star as shown in FIG. 8, and associates the authentication indicator with the piece of rare art or even the designated area associated the piece of rare art. In this manner, the user may plainly determine which items or designated areas in the virtual retail store are authenticated and may be trusted by the customer.

On the other hand, the three dimensional image enhancing device may alternatively not display an authentication indicator for items or items associated with a designated area not yet authenticated by the central computing device. Moreover, the three dimensional image enhancing device may further receive, from the central computing device, a “do not trust” indicator or fraud indicator that expressly notifies a customer or a user that the item or items associated with a designated area are not only not authenticated but should not be trusted because of potential fraud.

For example, as the shown in FIG. 8, the three dimensional image enhancing device may receive a fraud indicator from the central computing device for the designated area associated with snake oil. In this example, not only does the three dimensional image enhancing device not display an authentication indicator but the three dimensional image enhancing device may display the entire designated area associated with snake oil as being grayed out, made transparent, bordered with dashed lined, etc., to indicate that the snake oil items associated with the designated area are not to be trusted. Alternatively, the three dimensional image enhancing device may be implemented to not display the snake oil designated area all together to the user. Moreover, the three dimensional image enhancing device may block or expressly prohibit a user from purchasing an item from a non-verified merchant as well.

The three dimensional image enhancing device may additionally or alternatively communicate with a secondary device of the user's or with a secondary device present nearby in a retail store environment to authenticate the user. For example, the three dimensional image enhancing device may communicate with the user's smartphone, wearable device, custom tailor device, or any other mobile device associated with the user to perform a second factor authentication. In verifying the customer via a secondary device, bio-identification (i.e., retina images, etc.), or any other type of user identification technique, the three dimensional image enhancing device may further prevent friendly fraud by verifying that the user purchased the good and received the good. For example, if a user purchases and receives movie tickets wearing a three dimensional image enhancing device that has verified the identity of the user via a bio-identification technique, the user may not later claim that the movie tickets were never received while requesting a refund for the purchase amount because the three dimensional image enhancing device verified the user's identity before the purchase.

Furthermore, the three dimensional image enhancing device may include a processor (e.g., ARM or any other processor tailored for a mobile device) that may perform a secure payment transaction via a virtual NFC (Near Field Communication) implementation. In this way, the user may place a virtual token, virtual fob, or any other small virtual item close to the virtual item desired to purchase the item. In this way, the user may prevent accidentally purchasing an item by inadvertently reaching for a virtual item within the three dimensional virtual world as described above. In an alternative implementation, the user may employ the virtual NFC technique to verify the authenticity of an item, merchant, virtual website, etc., opposed to purchasing the item.

As described above, the three dimensional image enhancing device may receive verification information for the user for preventing fraud or for tailoring items offered to the user based on the user's preferences or other user information, such as age, address, income level, etc. For whatever the reason, if a user is not verified by the central computing device for a particular zone, the three dimensional image enhancing device may prompt the user with a question to elicit a challenge response that may verify the user. For example, the question may include private information only known to the user. Furthermore, as described above, the three dimensional image enhancing device may communicate with a secondary device of the user, such as sending a text, message, etc., to the user's secondary device for confirmation of the user's identity.

Moreover, the three dimensional image enhancing device may send alert notifications to the user when a purchase or an item return has occurred to help further prevent fraud or theft. After a user has conducted a purchase, the three dimensional image enhancing device may display the tracking information to the user in a visual manner that allows the user change the type of shipment (e.g., overnight, two day, etc. shipping), the shipping carrier, cancelling the order/shipment, or any other aspect of the shipment via hand movements within the three dimensional environment. This shipping and tracking information may also be sent to the secondary device of the user as a text, email, etc.

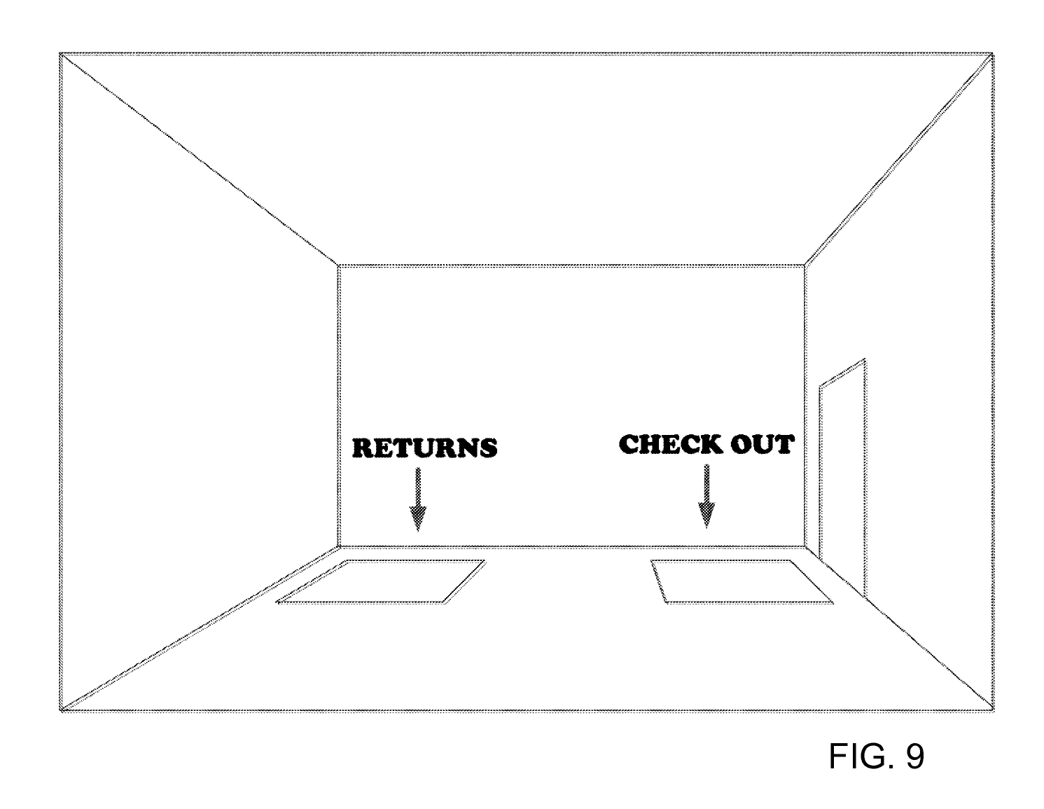

Referring back to the virtual retail store as described above, the three dimensional image enhancing device may additionally allow a user to collect items within the virtual retail store and check out and purchase all the items when the user has completed shopping. For example, as illustrated in FIG. 9, the three dimensional image enhancing device may display a “check out” designated area that allows the user to purchase all collected items while shopping within the virtual retail store. For example, a user may select items within a virtual retail store by reaching his or her arm out to virtually grab the item (similar to the techniques described above and illustrated in FIGS. 6 and 7). In continuing this example, after collecting virtual items in a virtual basket (not shown) within the virtual retail store, the user may “move” or otherwise position himself or herself (i.e., using one of the techniques described above) within the designated check out area to purchase all the collected items. Because the three dimensional image enhancing device has received one or more verification messages that verify the user and the payment type of the user, the three dimensional image enhancing device may allow the user to purchase all collected items in response to the user entering the designated check out area. As shown in FIG. 9, for example, the designated check out area may be situated in front a virtual retail store door to charge customers as they leave the virtual retail store.

Additionally, the user may similarly return previously purchased items by moving or positioning himself or herself (i.e., using one of the techniques described above) within the designated return area as shown in FIG. 9. Likewise, the three dimensional image enhancing device may initiate the return of one or more previously purchased items or cancel an entire order in response to the user entering the designated return area.

Virtual geo-fencing may be used to designate different functions in the environment. For example, moving to the right (such as looking to the right, moving an arm to the right, pointing to the right, etc.) in an environment may take a user to a purchase area where the area may resemble a checkout area. Similarly, looking to the left (such as looking left, pointing left, leaning left, etc.) in an environment may take a user to a virtual return area. Logically, other movements may have similar results such as tilting a head in a quizzical manner may take a user to an information area. Once in these virtual geo-fenced areas, additional security measures may be implemented such as two factor authentication for purchases, etc.

If the user has been authenticated in a geo-fenced area, the authentication may be noted in a variety of ways. The user may hear a sound or a unique character or image may enter the environment in the user has been authenticated. Similarly, a separate sound may be played or a separate character or image may appear if the user has entered an area that is not secure or is considered unsafe. Likewise, a separate highlighting or background color may be used if an area is considered safe. As an example, if a vendor is a Visa® approved vendor, a friendly dog may appear or a pleasant sound may be played to a user and if a vendor is not a Visa® approved vendor, an angry or scared dog many appear or an unpleasant sound may be played. Further, if the vendor has additional Visa® services available such as Visa® Checkout, additional sounds and visual effects may be communicated to the user to make the user aware of the various payment options available to a user.

To assist a user in shopping, similar images and sounds may be used. For example, if a user is reviewing a good, a “purchase dog” may attempt to lead the user toward the checkout area. A separate image such as a curious otter may be presented to lead a user toward more information about a product. Finally, a groundhog may be used to lead a user toward a return area. Of course, the animals may be thought of as place-holders and may be replaced with colors, symbols, sounds and smells. Similarly, haptic feedback may be used alone or in combination to lead users toward areas of interest.

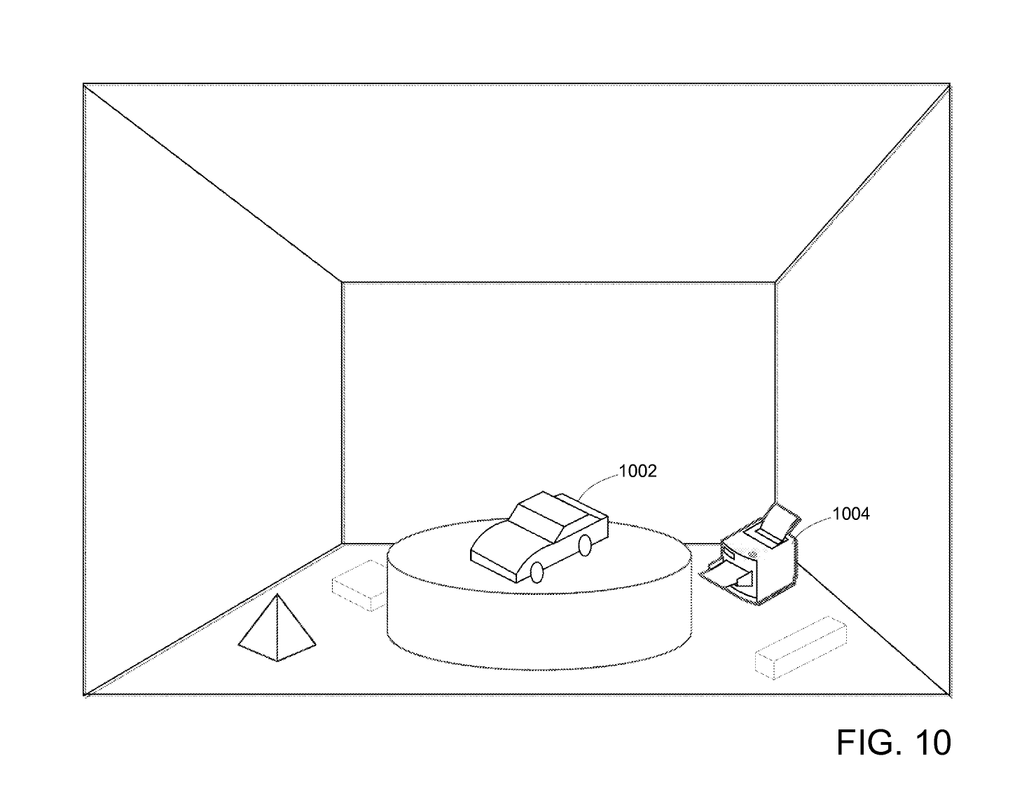

The three dimensional image enhancing device may also allow a user to virtually build three dimensional forms using his or her hands to move, modify, create virtual parts. For example, as illustrated in FIG. 10, the three dimensional image enhancing device is displaying and allowing a user to build a virtual model car 1002 (e.g. a toy car) using various virtual blocks or parts as shown on the ground. Moreover, the user may initiate the actual three dimensional printing of the model car by picking up the virtual model car and dropping the virtual model car on a virtual printer 1004. In response, the three dimensional image enhancing device may communicate with a three dimensional printer (not shown) to initiate the actual three dimensional printing of the model car.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, may comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

Still further, the figures depict preferred embodiments of a virtual environment authentication and transaction system for purposes of illustration only. One skilled in the art will readily recognize from the foregoing discussion that alternative embodiments of the structures and methods illustrated herein may be employed without departing from the principles described herein. Thus, upon reading this disclosure, those of skill in the art will appreciate still additional alternative structural and functional designs for a system and a process for authenticating users and performing transactions in a virtual environment through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computerized method for facilitating a purchase transaction for a user in a first reality environment, said first reality environment being provided to the user via a three-dimensional image enhancing device, said computerized method comprising:
receiving a first authentication data of the user from the three-dimensional image enhancing device;
comparing the received first authentication data of the user to a set of known authentication data of the user stored in a memory accessible by the three-dimensional image enhancing device;
in response to the comparing, receiving a second authentication data of the user from the three-dimensional image enhancing device;
comparing the received second authentication data of the user to the set of known authentication data of the user stored in the memory accessible by the three-dimensional image enhancing device;
in response to the comparing, providing an object to the user for purchase in the first reality environment via the three-dimensional image enhancing device;
identifying an interaction of the user in a second reality environment to interact with the provided object in the first reality environment;
determining the identified interaction to complete the purchase transaction of the object; and
completing the purchase transaction of the object in response to the determination being affirmative.

2. The computerized method of claim 1, wherein the first authentication data comprises data captured by sensors of the three-dimensional image enhancing device.

3. The computerized method of claim 1, wherein the second authentication data comprises data captured outside the three-dimensional image enhancing device.

4. The computerized method of claim 1, wherein providing the object to the user for purchase comprises providing the object based on a set of preferences of the user.

5. The computerized method of claim 1, wherein providing the object for purchase comprises selectively providing the object in the first reality environment via the three-dimensional image enhancing device in response to receiving authentication data of a merchant, wherein the object comprises goods or services provided by the merchant.

6. The computerized method of claim 5, further comprising receiving authentication data of the object before providing the object for purchase.

7. The computerized method of claim 1, further comprising:
receiving virtual geo-fenced area data indicating a specific geo-fence area within the first reality environment;
receiving an indication of movements from the user, the movement indicating the desire to change a spatial position of the user within the first reality environment;
determining authentication rights of the user for the received virtual geo-fenced area based on the comparing of the first authentication data and the second authentication data to the known authentication data of the user; and
providing via the three-dimensional image enhancing device a notification to the user that the virtual geo-fenced area is authenticated for the user.

8. The computerized method of claim 7, further comprising selectively providing settings in the first reality environment via the three-dimensional image enhancing device in response to the determined authentication rights.

9. The computerized method of claim 1, further comprising:
receiving geo-fenced area data indicating a specific geo-fence area within the second reality environment;
receiving another indication of movements from the user, the movements indicating the desire to change a spatial position of the user within the second reality environment;
determining authentication rights of the user for the received geo-fenced area based on the comparing of the first authentication data and the second authentication data to the known authentication data of the user; and
providing an object or a change to a background in the first reality environment via the three-dimensional image enhancing device.

10. The computerized method of claim 1, wherein the first authentication data and the second authorization data comprise the first authentication data and the second authorization data associated with the user wearing the three-dimensional image enhancing device.

11. A computerized method for facilitating a purchase transaction for a user in a first reality environment, said first reality environment being provided to the user via a three-dimensional image enhancing device, said computerized method comprising:
receiving at least one level of authentication data of the user from the three-dimensional image enhancing device, said at least one level of authentication data comprising at least one of the following: image data obtained via the three-dimensional image enhancing device, audio data from a second reality environment, visual data from the second reality environment, location-based data from the second reality environment and a combination of sound data and image data, said second reality environment being different from the first reality environment;
transmitting the received at least one level of authentication data to a central computing device for comparing the received at least one level of authentication data of the user to a set of known authentication data of the user stored in a memory accessible by the central computing device and the three-dimensional image enhancing device;
in response to receiving a confirmation from the central computing device, providing an object to the user for purchase in the first reality environment via the three-dimensional image enhancing device;
identifying an interaction of the user to interact with the provided object in the first reality environment;
determining the identified interaction to complete the purchase transaction of the object; and
completing the purchase transaction of the object in response to the determination being affirmative.

12. The computerized method of claim 11, wherein identifying comprises identifying the moments of an external device engaged with the user, said external device being configured to control a cursor visible in the first reality environment via the three-dimensional image enhancing device.

13. The computerized method of claim 11, wherein determining the identified interaction to complete the purchase transaction comprises comparing the interaction to a signature of the user stored in the memory.

14. The computerized method of claim 11, wherein providing the object to the user for purchase comprises providing the object based on a set of preferences of the user.

15. The computerized method of claim 11, wherein providing the object for purchase comprises selectively providing the object in the first reality environment via the three-dimensional image enhancing device in response to receiving authentication data of a merchant, wherein the object comprises goods or services provided by the merchant.

16. The computerized method of claim 15, further comprising receiving authentication data of the object before providing the object for purchase.

17. A system for facilitating a purchase transaction for a user in a first reality environment, said system comprising:
a three-dimensional image enhancing device for providing the first reality environment to the user, wherein the user is sensory responsive to the first reality environment and a second reality environment, said second reality environment being different from the first reality environment;
wherein the three-dimensional image enhancing device comprises a memory and a processor, said processor configured to execute computer-executable instructions;
a central computing device accessible to a central memory via a network, said processor being accessible to the central computing device via the network;
wherein the processor receives at least one level of authentication data of the user from the three-dimensional image enhancing device, said at least one level of authentication data comprising at least one of the following: image data obtained via the three-dimensional image enhancing device, audio data from a second reality environment, visual data from the second reality environment, location-based data from the second reality environment and a combination of sound data and image data;
wherein the processor transmits the received at least one level of authentication data to the central computing device for comparing the received at least one level of authentication data of the user to a set of known authentication data of the user stored in the central memory to validate the user;
in response to the comparing, the central computing device transmits a confirmation to the processor;
wherein the processor provides an object to the user for purchase in the first reality environment via the three-dimensional image enhancing device;
wherein the processor identifies an interaction of the user in the second reality environment to interact with the provided object in the first reality environment;
wherein the processor determines the identified interaction to complete the purchase transaction of the object; and
wherein the processor completes the purchase transaction of the object in response to the determination being affirmative.

18. The system of claim 17, wherein the processor is further configured to execute computer-executable instructions for:
receiving virtual geo-fenced area data indicating a specific geo-fence area within the first reality environment;
receiving an indication of movements from the user, the movement indicating the desire to change a spatial position of the user within the first reality environment;
determining authentication rights of the user for the received virtual geo-fenced area based on the comparing of the first authentication data and the second authentication data to the known authentication data of the user; and
providing via the three-dimensional image enhancing device a notification to the user that the virtual geo-fenced area is authenticated for the user.

19. The system of claim 18, wherein the processor selectively provides settings in the first reality environment via the three-dimensional image enhancing device in response to the determined authentication rights.

20. The system of claim 17, wherein the processor is further configured to execute computer-executable instructions for:
receiving geo-fenced area data indicating a specific geo-fence area within the second reality environment;
receiving another indication of movements from the user, the movements indicating the desire to change a spatial position of the user within the second reality environment;
determining authentication rights of the user for the received geo-fenced area based on the comparing of the first authentication data and the second authentication data to the known authentication data of the user; and
providing an object or a change to a background in the first reality environment via the three-dimensional image enhancing device.
